(19) United States
(12) Patent Application Publication
(10) Pub. No.: US 2013/0214035 A1
(43) Pub. Date: Aug. 22, 2013

(54) Reusable Paper Pan

(71) Applicant: Chih-Wei Huang, Tainan City (TW)

(72) Inventor: Chih-Wei Huang, Tainan City (TW)

(21) Appl. No.: 13/398,907

(22) Filed: Feb. 17, 2012

(51) Int. Cl. A47J 37/01; B65D 5/56; B65D 5/64; B65D 5/44; B65D 5/62; A47J 36/04

(52) U.S. Cl. 229/116.2; 229/199; 229/116.1; 229/125.13; 229/100

(57) ABSTRACT

A reusable paper pan includes a main body, and a holding device mounted on the main body to hold a shape of the main body. The main body includes a container and a plurality of first connecting members provided on the container. The holding device includes at least one positioning member surrounding the container, and a plurality of second connecting members provided on the positioning member and connected with the first connecting members. Thus, the positioning member of the holding device surrounds and compresses the periphery of the container to keep the shape of the container so that the container of the main body will not be deformed when the foods in the container of the main body are baked and expanded.

### BACKGROUND OF THE INVENTION

1. Field of the Invention

The present invention relates to a pan made of paper and, more particularly, to a reusable paper pan for placing and baking foods in a broiler or baking oven.

2. Description of the Related Art

A conventional paper baking pan comprises a pan body made of paper material, and at least one connecting member connected with the pan body. The pan body has a plurality of folding edges, and the connecting member is combined with the folding edges of the pan body to keep the profile of the pan body. However, the pan body is limited by the folding edges so that the shape of the pan body is restricted and cannot be changed freely. In addition, the paper baking pan needs to provide a connecting member to keep the profile of the pan body, thereby increasing the costs of fabrication.

### BRIEF SUMMARY OF THE INVENTION

In accordance with the present invention, there is provided a reusable paper pan, comprising a main body, and a holding device mounted on the main body to hold a shape of the main body so as to prevent the main body from being deformed. The main body is made of a paper material and includes a container and a plurality of first connecting members provided on the container. The container of the main body is folded integrally to have a determined hollow shape. The holding device includes at least one positioning member surrounding a periphery of the container of the main body, and a plurality of second connecting members provided on the positioning member and connected with the first connecting members of the main body. The positioning member of the holding device compresses the periphery of the container of the main body and has a profile matching that of the container of the main body to keep the shape of the container of the main body.

Preferably, the container of the main body has a substantially rectangular, circular, polygonal, heart or star shape.

Preferably, the reusable paper pan further comprises a top cover mounted on the main body to cover the main body. The top cover includes a cover body covering the container of the main body to cover the container of the main body, and a plurality of connecting plates provided on the cover body and connected with the first connecting members of the main body. The cover body of the top cover has a shape the same as that of the container of the main body to completely cover an open top of the container of the main body. The cover body of the top cover has a peripheral wall provided with an abutting edge abutting the container of the main body. The abutting edge of the cover body extends downward and is inserted into a gap defined between the cover body of the top cover and the container of the main body.

Preferably, the top cover further includes a handle provided on the cover body.

Preferably, each of the first connecting members of the main body is an elongate slit, each of the second connecting members of the holding device is a snap-fit flange and is snapped into each of the first connecting members of the main body, and each of the connecting plates of the top cover extends downward from the cover body and is snapped into each of the first connecting members of the main body to affix the cover body to the main body and to combine the top cover with the main body.

Preferably, each of the connecting plates of the top cover has two opposite sides each provided with a locking hook hooked onto each of the first connecting members of the main body.

Preferably, the positioning member of the holding device and the container of the main body are formed integrally.

Preferably, the container of the main body is provided with a bent reinforcement face abutting the positioning member of the holding device to reinforce a combination strength of the container of the main body and the positioning member of the holding device.

Preferably, the reusable paper pan further comprises a plurality of fastening members extended through the positioning member of the holding device and the container of the main body to fasten the positioning member of the holding device with the container of the main body.

Preferably, the reusable paper pan further comprises a plurality of fastening members extended through the positioning member of the holding device, the container of the main body and the top cover to fasten the positioning member of the holding device, the container of the main body and the top cover.

According to the primary advantage of the present invention, the positioning member of the holding device surrounds and compresses the periphery of the container of the main body to keep the shape of the container of the main body so that the container of the main body will not be deformed when the foods in the container of the main body are baked and expanded so as to foam the profile of the foods exactly.

According to another advantage of the present invention, the reusable paper pan can be detached and washed after use so that the reusable paper pan can be reused successively.

According to a further advantage of the present invention, the reusable paper pan has different shapes to satisfy the consumer's variable requirements.

According to a further advantage of the present invention, the positioning member of the holding device has a shape corresponding to that of the container of the main body so that the shape of the main body can be changed freely without any restriction.

According to a further advantage of the present invention, all parts of the reusable paper pan are made of paper material to decrease the costs of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a reusable paper pan in accordance with the preferred embodiment of the present invention.

FIG. 2 is a partially perspective expanded view of the reusable paper pan as shown in FIG. 1.

FIG. 3 is a partially side cross-sectional view of the reusable paper pan as shown in FIG. 1.

FIG. 4 is an exploded perspective view of a reusable paper pan in accordance with another preferred embodiment of the present invention.

FIG. 5 is a perspective view of a reusable paper pan in accordance with a further preferred embodiment of the present invention.

FIG. 6 is a partially perspective expanded view of the reusable paper pan as shown in FIG. 5.

FIG. 7 is a partially exploded perspective view of a reusable paper pan in accordance with a further preferred embodiment of the present invention.

FIG. 8 is a perspective view of a reusable paper pan in accordance with a further preferred embodiment of the present invention.

FIG. 9 is an exploded perspective view of the reusable paper pan as shown in FIG. 8.

FIG. 10 is an exploded perspective view of a reusable paper pan in accordance with a further preferred embodiment of the present invention.

FIG. 11 is an exploded perspective view of a reusable paper pan in accordance with a further preferred embodiment of the present invention.

### DETAILED DESCRIPTION OF THE INVENTION

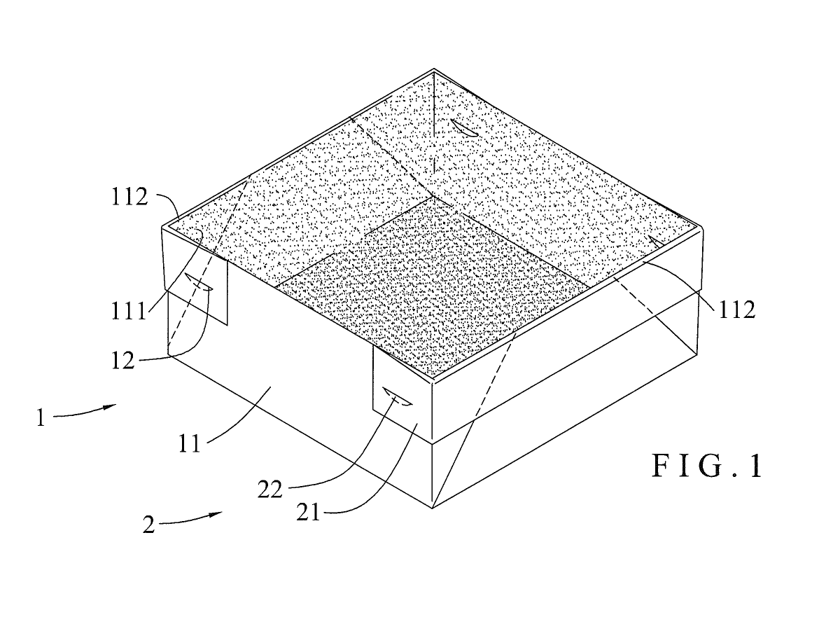

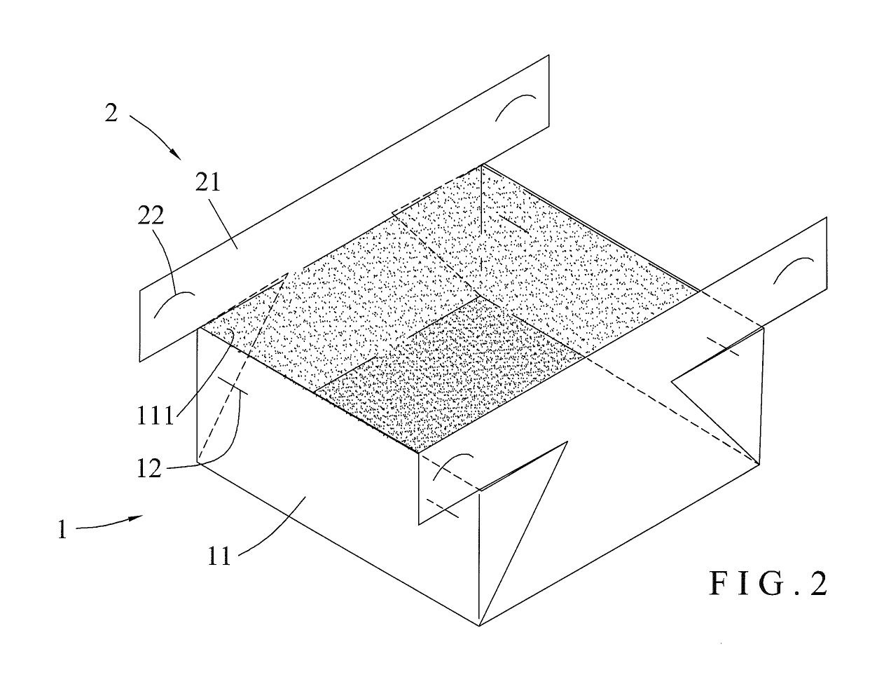

Referring to the drawings and initially to FIGS. 1-3, a reusable paper pan in accordance with the preferred embodiment of the present invention comprises a main body 1, and a holding device 2 mounted on the main body 1 to hold the shape of the main body 1 so as to prevent the main body 1 from being deformed.

The main body 1 is used to place and receive foods, such as cakes, breads and the like. The main body 1 is made of a paper material and includes a container 11 and a plurality of first connecting members 12 provided on the container 11. The container 11 of the main body 1 is folded integrally to have a determined hollow shape. In the preferred embodiment of the present invention, the container 11 of the main body 1 has a substantially rectangular shape, and each of the first connecting members 12 of the main body 1 is an elongate slit. Alternatively, the container 11 of the main body 1 has a substantially circular, polygonal, heart or star shape.

The holding device 2 is made of a paper material and includes at least one positioning member 21 surrounding a periphery of the container 11 of the main body 1, and a plurality of second connecting members 22 provided on the positioning member 21 and connected with the first connecting members 12 of the main body 1. The positioning member 21 of the holding device 2 surrounds and compresses the periphery of the container 11 of the main body 1 and has a profile matching that of the container 11 of the main body 1 to keep the shape of the container 11 of the main body 1. Preferably, the positioning member 21 of the holding device 2 and the container 11 of the main body 1 are formed integrally.

In the preferred embodiment of the present invention, the holding device 2 includes two opposite positioning members 21 surrounding the periphery of the container 11 of the main body 1, and each of the two positioning members 21 of the holding device 2 and the container 11 of the main body 1 are formed integrally. In addition, each of the two positioning members 21 of the holding device 2 is provided with a plurality of second connecting members 22, and each of the second connecting members 22 of the holding device 2 is a snap-fit flange and is snapped into each of the first connecting members 12 of the main body 1.

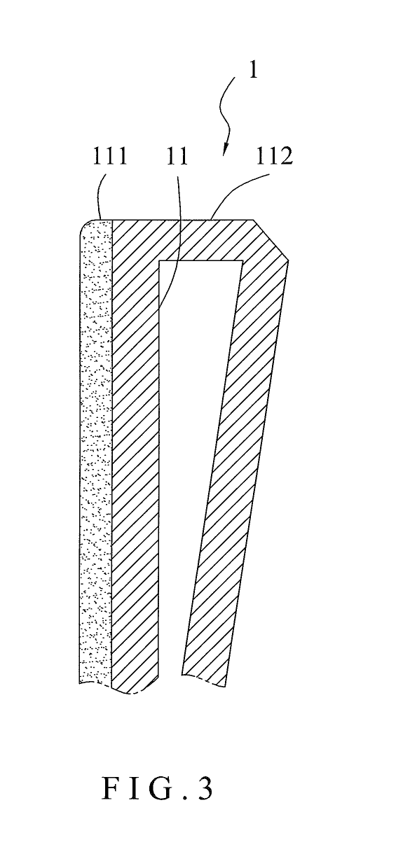

As shown in FIGS. 1 and 3, the container 11 of the main body 1 is provided with a bent reinforcement face 112 abutting the positioning member 21 of the holding device 2 to reinforce a combination strength of the container 11 of the main body 1 and the positioning member 21 of the holding device 2. In addition, the container 11 of the main body 1 has an inner face 111 provided with a silicon gel to isolate the container 11 of the main body 1 from the food so that the main body 1 can be reused.

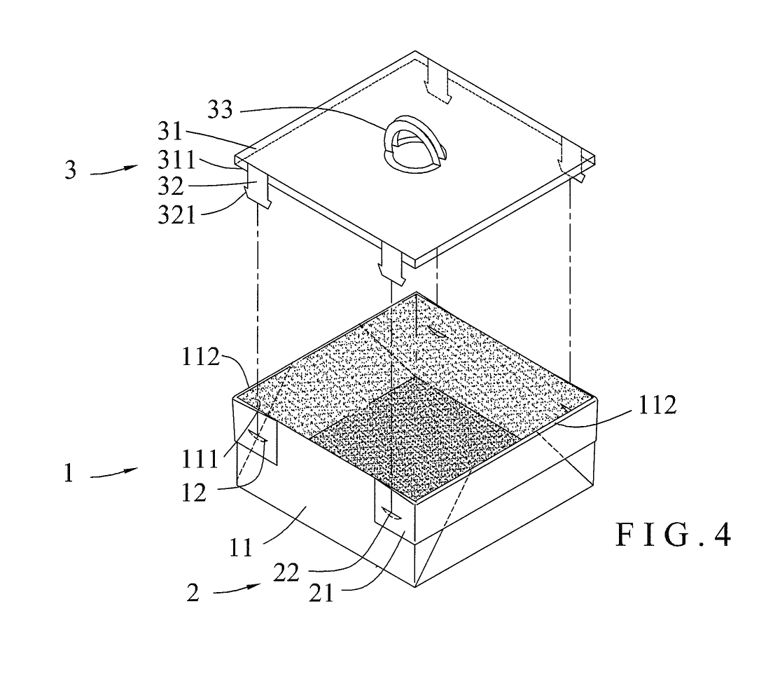

Referring to FIG. 4, the reusable paper pan further comprises a top cover 3 mounted on the main body 1 to cover the main body 1. The top cover 3 is made of a paper material and includes a cover body 31 covering the container 11 of the main body 1 to cover the container 11 of the main body 1, a plurality of connecting plates 32 provided on the cover body 31 and connected with the first connecting members 12 of the main body 1, and a handle 33 provided on the cover body 31. The cover body 31 of the top cover 3 has a shape the same as that of the container 11 of the main body 1 to completely cover an open top of the container 11 of the main body 1. The cover body 31 of the top cover 3 has a peripheral wall provided with an abutting edge 311 abutting the container 11 of the main body 1. The abutting edge 311 of the cover body 31 extends downward and is inserted into a gap defined between the cover body 31 of the top cover 3 and the container 11 of the main body 1 so that the cover body 31 of the top cover 3 is fitted onto the container 11 of the main body 1 closely and tightly. Each of the connecting plates 32 of the top cover 3 extends downward from the cover body 31 and is snapped into each of the first connecting members 12 of the main body 1 to affix the cover body 31 to the main body 1 and to combine the top cover 3 with the main body 1. Each of the connecting plates 32 of the top cover 3 has two opposite sides each provided with a locking hook 321 hooked onto each of the first connecting members 12 of the main body 1. The handle 33 and the cover body 31 of the top cover 3 are formed integrally.

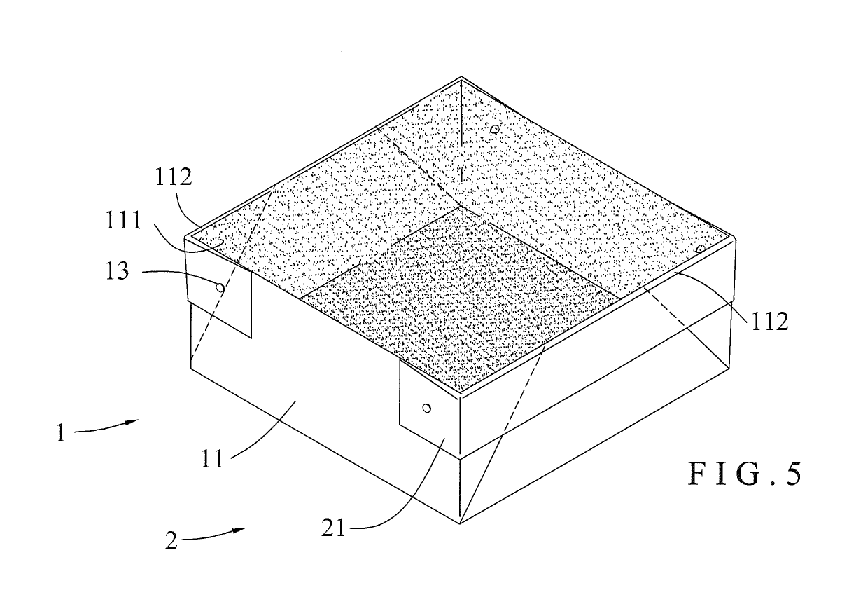

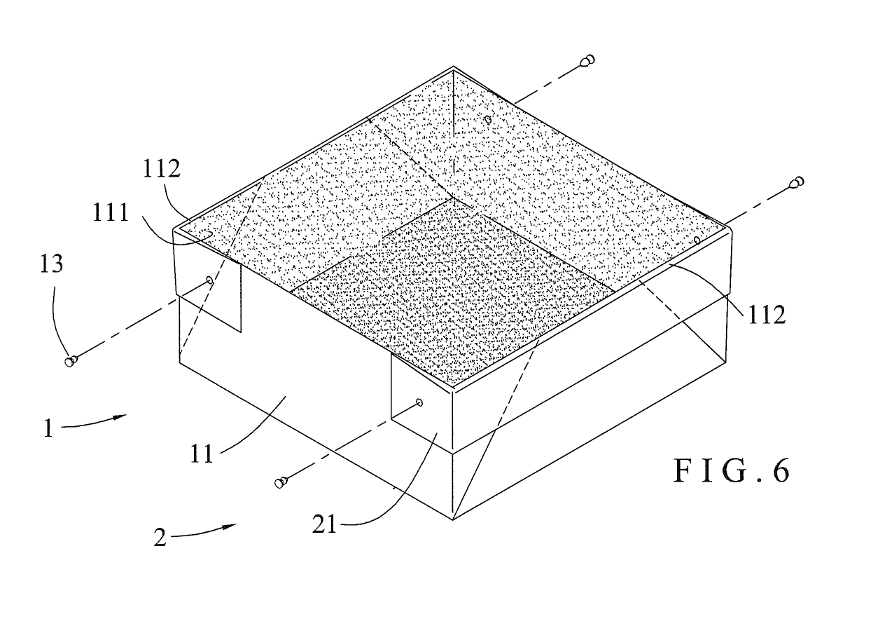

Referring to FIGS. 5 and 6, the reusable paper pan further comprises a plurality of fastening members 13 extended through the positioning member 21 of the holding device 2 and the container 11 of the main body 1 to fasten the positioning member 21 of the holding device 2 with the container 11 of the main body 1. In the preferred embodiment of the present invention, the reusable paper pan comprises four fastening members 13 extended through the positioning member 21 of the holding device 2 and the container 11 of the main body 1.

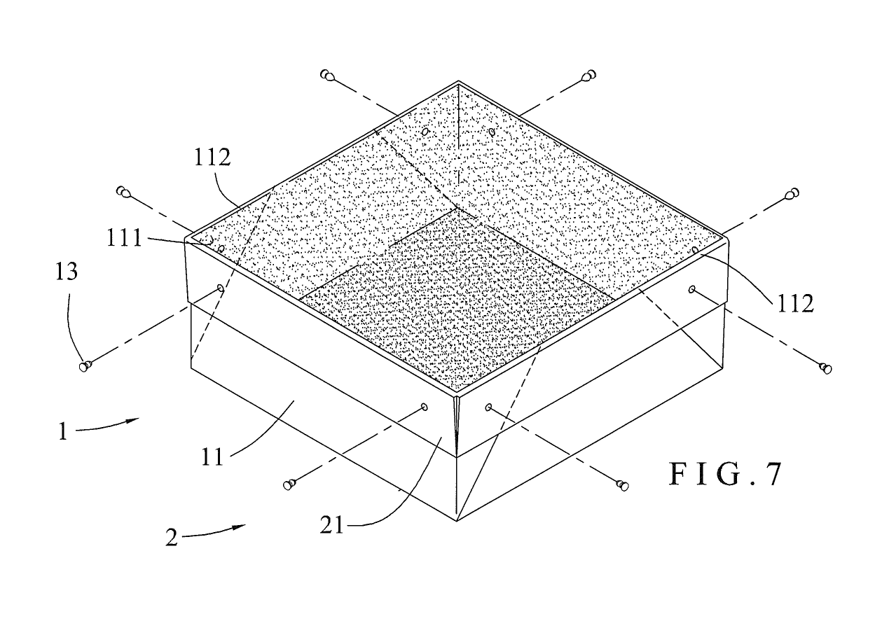

Referring to FIG. 7, the reusable paper pan comprises eight fastening members 13 extended through the positioning member 21 of the holding device 2 and the container 11 of the main body 1.

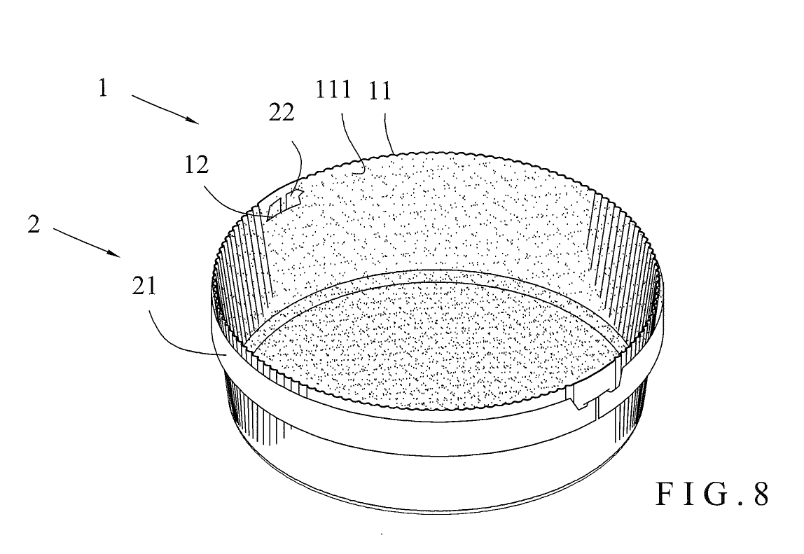

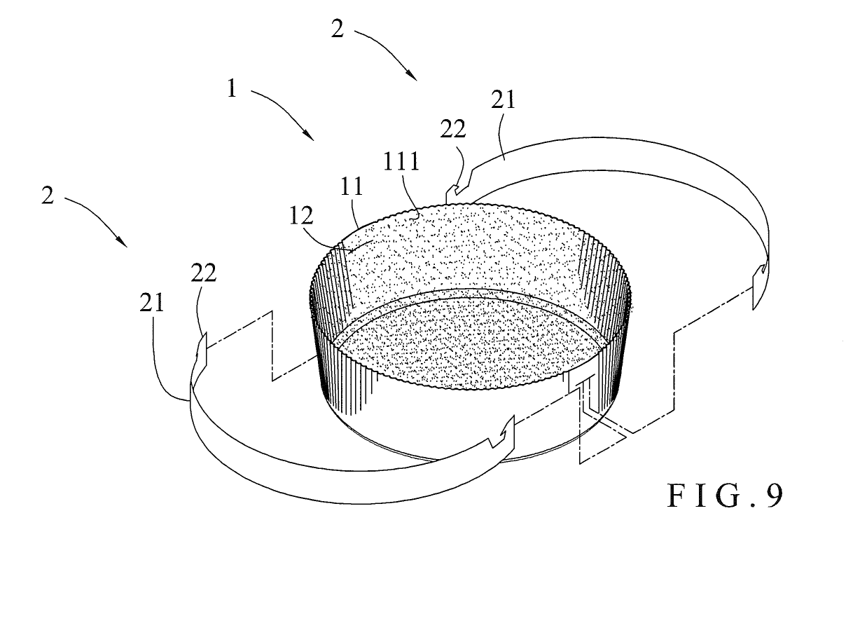

Referring to FIGS. 8 and 9, the container 11 of the main body 1 has a substantially circular shape, and each of the first connecting members 12 of the main body 1 is an elongate slit. The positioning member 21 of the holding device 2 has a substantially arc-shaped profile and is secured on the periphery of the container 11 of the main body 1 to keep the shape of the container 11 of the main body 1. Preferably, the positioning member 21 of the holding device 2 and the container 11 of the main body 1 are provided individually. In the preferred embodiment of the present invention, the holding device 2 includes two opposite positioning members 21 surrounding the periphery of the container 11 of the main body 1. In addition, each of the two positioning members 21 of the holding device 2 is provided with two second connecting members 22, and each of the second connecting members 22 of the holding device 2 is a hook which is hooked onto each of the first connecting members 12 of the main body 1.

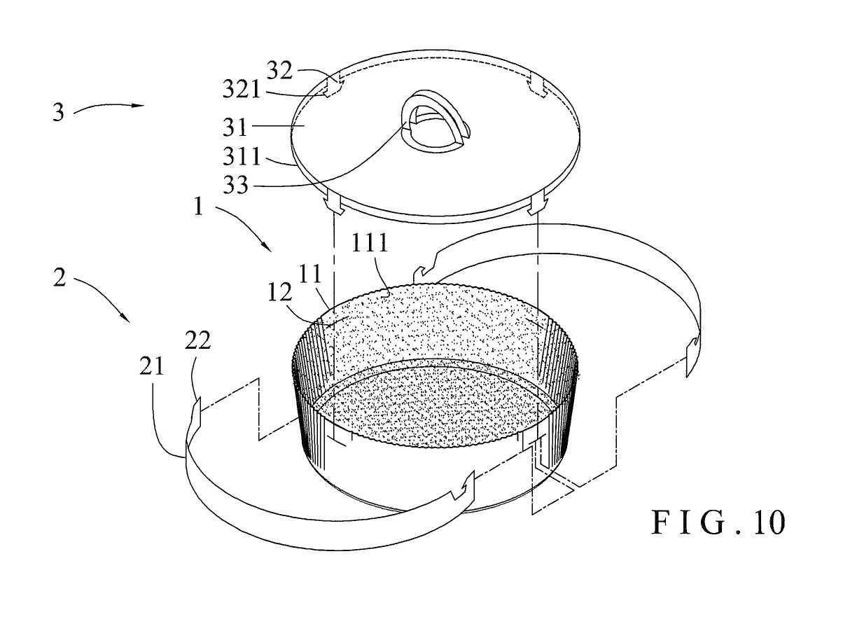

Referring to FIG. 10, the cover body 31 of the top cover 3 has a circular shape to completely cover an open top of the container 11 of the main body 1. The cover body 31 of the top cover 3 has a peripheral wall provided with an abutting edge 311 which has a circular shape. Each of the connecting plates 32 of the top cover 3 extends downward from the cover body 31 and is snapped into each of the first connecting members 12 of the main body 1 to affix the cover body 31 to the main body 1 and to combine the top cover 3 with the main body 1. Each of the connecting plates 32 of the top cover 3 has two opposite sides each provided with a locking hook 321 hooked onto each of the first connecting members 12 of the main body 1. The handle 33 and the cover body 31 of the top cover 3 are formed integrally.

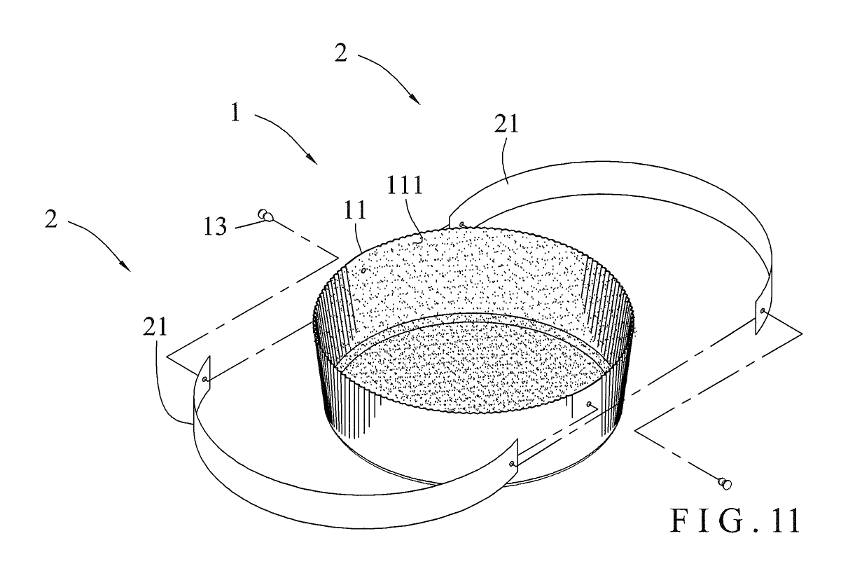

Referring to FIG. 11, the reusable paper pan further comprises a plurality of fastening members 13 extended through the positioning member 21 of the holding device 2 and the container 11 of the main body 1 to fasten the positioning member 21 of the holding device 2 with the container 11 of the main body 1.

Accordingly, the positioning member 21 of the holding device 2 surrounds and compresses the periphery of the container 11 of the main body 1 to keep the shape of the container 11 of the main body 1 so that the container 11 of the main body 1 will not be deformed when the foods in the container 11 of the main body 1 are baked and expanded so as to form the profile of the foods exactly. In addition, the reusable paper pan can be detached and washed after use so that the reusable paper pan can be reused successively. Further, the reusable paper pan has different shapes to satisfy the consumer's variable requirements. Further, the positioning member 21 of the holding device 2 has a shape corresponding to that of the container 11 of the main body 1 so that the shape of the main body 1 can be changed freely without any restriction. Further, all parts of the reusable paper pan are made of paper material to decrease the costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A reusable paper pan, comprising:
a main body; and
a holding device mounted on the main body to hold a shape of the main body so as to prevent the main body from being deformed;
wherein the main body is made of a paper material and includes:
a container; and
a plurality of first connecting members provided on the container;
the container of the main body is folded integrally to have a determined hollow shape;
the holding device includes:
at least one positioning member surrounding a periphery of the container of the main body; and
a plurality of second connecting members provided on the positioning member and connected with the first connecting members of the main body;
the positioning member of the holding device compresses the periphery of the container of the main body and has a profile matching that of the container of the main body to keep the shape of the container of the main body.

2. The reusable paper pan of claim 1, wherein the container of the main body has a substantially rectangular, circular, polygonal, heart or star shape.

3. The reusable paper pan of claim 1, wherein
the reusable paper pan further comprises a top cover mounted on the main body to cover the main body;
the top cover includes:
a cover body covering the container of the main body to cover the container of the main body; and
a plurality of connecting plates provided on the cover body and connected with the first connecting members of the main body;
the cover body of the top cover has a shape the same as that of the container of the main body to completely cover an open top of the container of the main body;
the cover body of the top cover has a peripheral wall provided with an abutting edge abutting the container of the main body;
the abutting edge of the cover body extends downward and is inserted into a gap defined between the cover body of the top cover and the container of the main body.

4. The reusable paper pan of claim 3, wherein the top cover further includes a handle provided on the cover body.

5. The reusable paper pan of claim 3, wherein
each of the first connecting members of the main body is an elongate slit;
each of the second connecting members of the holding device is a snap-fit flange and is snapped into each of the first connecting members of the main body;
each of the connecting plates of the top cover extends downward from the cover body and is snapped into each of the first connecting members of the main body to affix the cover body to the main body and to combine the top cover with the main body.

6. The reusable paper pan of claim 3, wherein each of the connecting plates of the top cover has two opposite sides each provided with a locking hook hooked onto each of the first connecting members of the main body.

7. The reusable paper pan of claim 1, wherein the positioning member of the holding device and the container of the main body are formed integrally.

8. The reusable paper pan of claim 1, wherein the container of the main body is provided with a bent reinforcement face abutting the positioning member of the holding device to reinforce a combination strength of the container of the main body and the positioning member of the holding device.

9. The reusable paper pan of claim 1, wherein the reusable paper pan further comprises a plurality of fastening members extended through the positioning member of the holding device and the container of the main body to fasten the positioning member of the holding device with the container of the main body.

10. The reusable paper pan of claim 1, wherein the container of the main body has an inner face provided with a silicon gel.

11. The reusable paper pan of claim 3, wherein the reusable paper pan further comprises a plurality of fastening members extended through the positioning member of the holding device, the container of the main body and the top cover to fasten the positioning member of the holding device, the container of the main body and the top cover.
